(19) United States
(12) Patent Application Publication
(10) Pub. No.: US 2024/0415119 A1
(43) Pub. Date: Dec. 19, 2024

(54) INSECT PEST-CONTROLLING TOOL FOR ANIMALS

(71) Applicant: OSAKA PHARMACEUTICAL CO., LTD., Osaka (JP)

(72) Inventors: Yoshiaki YOSHIOKA, Osaka (JP); Hiroyuki INAMI, Osaka (JP)

(21) Appl. No.: 18/695,053

(22) PCT Filed: Sep. 26, 2022
(86) PCT No.: PCT/JP2022/035694

§ 371 Date: Mar. 25, 2024

(30) Foreign Application Priority Data
Sep. 28, 2021 (JP) 2021-157441

(51) Int. Cl. A01N 25/34; A01N 39/00; A01N 47/02; A01N 53/00; A01P 7/04

(52) U.S. Cl. CPC A01N 25/34; A01N 39/00; A01N 47/02; A01N 53/00; A01P 7/04

(57) ABSTRACT

An insect pest-controlling tool for animals is provided.

The present invention provides an insect pest-controlling tool for animals comprising: at least one or more active ingredients selected from the group consisting of pyrethroid compounds, phenylpyrazole compounds, and macrolide compounds; and at least one solvent selected from the group consisting of diethylene glycol monoethyl ether, benzyl alcohol, ethyl lactate, and triglyceride of medium chain fatty acids. The container body is composed of an olefinic resin layer, an alicyclic olefinic resin layer, an olefinic resin layer, and a polyethylene terephthalate layer or an ethylene-vinyl alcohol copolymer layer. The olefinic resin layer is in contact with the agent.

### TECHNICAL FIELD

The present invention relates to a controlling tool having elimination efficacy against insect pests, such as mites, fleas, and mosquitoes, which attach to animals, such as companion animals and domestic animals. More specifically, the present invention relates to an insect pest-controlling tool for animals, comprising an agent for elimination of these insect pests, wherein the agent is held in a container that is of a laminate of specified resins.

Conventionally, in order to exterminate insect pests that attach to pets such as dogs, cats, and rabbits, and livestock such as pigs and cattle and have harmful effects on them, various kinds of pest control agents are known that are applied by dropping, spraying, or applying to the body surface of such animals to exterminate them.

For example, Patent Document 1 discloses a pest control agent containing insecticidal ingredients such as phenothrin and aresolin, and diethylene glycol monoethyl ether as a solvent to control cat flea parasites on cats.

### Prior Art Documents

### Patent Documents

Patent document 1 Laid-Open JP2009-234922

### SUMMARY OF THE INVENTION

### Problems to be Solved by the Invention

However, there is a problem of odor leakage from the container of an insect pest-controlling tool for animals, depending on the physical properties of the solvent employed and others, and on the combination of the active ingredient and the solvent employed. When the gas permeability of the container is reduced, thereby attaching importance to the hermetic property thereof, other physical properties may be adversely affected, and therefore it is very difficult to produce an insect pest-controlling tool for animals, comprising a container satisfying physical properties like the stability of the contents contained therein, the transparency thereof, ease of breakage thereof when it is applied, and ease of molding thereof.

The present invention relates to an insect pest-controlling tool for animals that has elimination efficacy against insect pests, such as mites, fleas, and mosquitoes, which attach to animals having relationships with people, like companion animals, domestic animals, and like. The present invention aims at providing, as such a tool, an insect pest-controlling tool for animals, comprising a container which allows stable holding of the agent therein, and at the same time, results in suppression of gas permeation therethrough and is excellent in the transparency thereof, ease of breakage thereof when it is applied, ease of molding thereof, and others.

### Means for Solving the Problems

The present inventors have found that it is possible to obtain an insect pest-controlling tool for animals, comprising a container body provided also with excellent physical properties, by employing a container of a laminate comprising an olefin resin layer, an alicyclic olefin resin layer, an olefin resin layer, and a polyethylene terephthalate layer or an ethylene-vinyl alcohol copolymer layer, as a container in which an agent containing at least one or more active ingredients selected from the group consisting of a pyrethroid compound, a phenylpyrazole compound, and a macrolide compound, and a specified solvent is held. The present invention has been completed based on these findings.

Accordingly, the present invention provides:

[1] An insect pest-controlling tool for animals, comprising:

an agent containing:

at least one active ingredient selected from the group consisting of a pyrethroid compound, a phenylpyrazole compound, and a macrolide compound; and

at least one solvent selected from the group consisting of diethylene glycol monoethyl ether, benzyl alcohol, ethyl lactate, and a medium-chain fatty acid triglyceride; and

a container body in which the agent is held,

wherein the container body is of a laminate comprising a first olefin resin layer, an alicyclic olefin resin layer, a second olefin resin layer, and a polyethylene terephthalate layer or an ethylene-vinyl alcohol copolymer layer, and

wherein the first olefin resin layer is placed facing the agent:

[2] The insect pest-controlling tool for animals according to [1], further comprising a lid part that covers an opening of the container body and is of a laminate of two or more materials selected from the group consisting of an alicyclic olefin resin, polyethylene terephthalate, polypropylene, polyethylene, and aluminum:

[3] The insect pest-controlling tool for animals according to [1] or [2], wherein the alicyclic olefin resin is a copolymer of norbornene and ethylene:

[4] The insect pest-controlling tool for animals according to any of [1] to [3], wherein each of the olefin resin layers is of a copolymer of polyethylene and polypropylene:

[5] The insect pest-controlling tool for animals according to any of [1] to [4], wherein the active ingredient is a pyrethroid compound, which is at least one selected from the group consisting of etofenprox, phenothrin, and allethrin:

[6] The insect pest-controlling tool for animals according to any of [1] to [4], wherein the active ingredient is a phenylpyrazole compound, fipronil;

and others as specified herein.

### Effect of the Invention

An insect pest-controlling tool for animals according to the present invention is one comprising a container body which results in suppression of gas permeation therethrough and is provided also with the transparency thereof, ease of breakage thereof when it is applied, and ease of molding thereof.

### BRIEF DESCRIPTION OF THE DRAWING

FIG. 1 shows an embodiment of a laminate forming the container body of an insect pest-controlling tool for animals according to the present invention.

### MODE FOR CARRYING OUT THE INVENTION

Hereinafter, modes for carrying out the present invention will be described in detail. However, the present invention is not limited to the embodiments described below.

### [Insect Pest-Controlling Tools for Animals] (Animals)

An animal as used herein includes companion animals, without limitation, such as dogs, cats, rabbits, and hamsters, and domestic animals, without limitation, such as cows and pigs.

### (Insect Pests)

An insect pest as used herein includes public health insect pests, without limitation, such as mites (such as ticks), fleas, lice, mosquitoes, black flies, house flies, bedbugs, and horse flies. Insect pests of subject that are particularly preferable as a target are mites, fleas or mosquitoes.

### (Active Ingredients in the Agent)

The agent for use in an insect pest-controlling tool for animals according to the present invention includes at least one or more active ingredients selected from the group consisting of a pyrethroid compound, a phenylpyrazole compound, and a macrolide compound.

The pyrethroid compound in the present invention includes natural and synthetic pyrethroids. The natural pyrethroid in the present invention preferably is pyrethrin I< (1R,3R)-2,2-dimethyl-3-(2-methyl-1-propenyl) cyclopropanecarboxylic acid (1S)-2-methyl-4-oxo-3-(2Z)-2,4-pentadienyl-2-cyclopenten-1-yl ester>, pyrethrin II< (1R,3R)-3-[(1E)-3-methoxy-2-methyl-3-oxo-1-propenyl]-2,2-dimethylcyclopropanecarboxylic acid (1S)-2-methyl-4-oxo-3-(2Z)-2,4-pentadienyl-2-cyclopenten-1-yl ester>, cynerin I< (1R,3R)-2,2-dimethyl-3-(2-methyl-1-propenyl) cyclopropanecarboxylic acid (1S)-3-(2Z)-(2-butenyl)-2-methyl-4-oxo-2-cyclopenten-1-yl ester>, cynerin II< (1R,3R)-3-[(1E)-3-methoxy-2-methyl-3-oxo-1-propenyl]-2,2-dimethylcyclopropanecarboxylic acid (1S)-3-(2Z)-(2-butenyl)-2-methyl-4-oxo-2-cyclopenten-1-yl ester>, jasmolin I< (1R,3R)-2,2-dimethyl-3-(2-methyl-1-propenyl) cyclopropanecarboxylic acid (1S)-2-methyl-4-oxo-3-(2Z)-2-pentenyl-2-cyclopenten-1-yl ester>, and jasmolin II < (1R,3R)-3-[(1E)-3-methoxy-2-methyl-3-oxo-1-propenyl]-2,2-dimethylcyclopropanecarboxylic acid (1S)-2-methyl-4-oxo-3-(2Z)-2-pentenyl-2-cyclopenten-1-yl ester>. The synthetic pyrethroid in the present invention preferably is allethrin I<2,2-dimethyl-3-(2-methyl-1-propenyl) cyclopropanecarboxylic acid 2-methyl-4-oxo-3-(2-propenyl)-2-cyclopenten-1-yl ester>, allethrin II<3-(3-methoxy-2-methyl-3-oxo-1-propenyl)-2,2-dimethylcyclopropanecarboxylic acid 2-methyl-4-oxo-3-(2-propenyl)-2-cyclopenten-1-yl ester>, d-allethrin <dl-3-allyl-2-methyl-4-oxo-2-cyclopentenyl dl-cis/trans-chrysanthemate>, phthalthrin (also known as D-tetramethrin) < (1,3-dioxo-4, 5, 6, 7-tetrahydroisoindolin-2-yl)methyl=2,2-dimethyl-3-(2-methylprop-1-en-1-yl) cyclopropane-1-carboxylate>, resmethrin < (5-benzyl-3-furyl)methyl=2,2-dimethyl-3-(2-methylprop-1-en-1-yl) cyclopropanecarboxylate>, phenothrin <3-phenoxybenzyl=2-dimethyl-3-(methylpropenyl)cyclopropanecarboxylate>, permethrin <3-phenoxybenzyl=3-(2,2-dichlorovinyl)-2,2-dimethylcyclopropanecarboxylate>, cyphenothrin <cyano (3-phenoxyphenyl)methyl=2,2-dimethyl-3-(2-methylprop-1-en-1-yl) cyclopropanecarboxylate>, etofenprox <4-(4-ethoxyphenyl)-4-methyl-1-(3-phenoxyphenyl)-2-oxapentane>, metofluthrin <2,2-dimethyl-3-(propa-1-en-1-yl) cyclopropanecarboxylic acid=2,3,5,6-tetrafluoro-4-(methoxymethyl)benzyl>, transfluthrin < (1R,3S)-3-[(E)-2,2-dichlorovinyl]-2,2-dimethylcyclopropanecarboxylic acid=2,3,5,6-tetrafluorobenzyl>, cyfluthrin <cyano (4-fluoro-3-phenoxyphenyl)methyl=3-(2,2-dichlorovinyl)-2,2-dimethylcyclopropane-1-carboxylate>, etofenprox <2-(4-ethoxyphenyl)-2-methylpropyl=3-phenoxybenzyl=ether>, and others. Among these, more preferable are etofenprox, permethrin, phenothrin, allethrin, phthalthrin, restmethrin, metofluthrin, and transfluthrin, and most preferable is etofenprox, phenothrin, or allethrin. The pyrethroid compounds described above can be used alone or in combination of two or more.

The phenylpyrazole compound in the present invention is a compound having a structure in which a phenyl group is substituted at position 1 of the nitrogen-containing pentacyclic pyrazole ring. The phenylpyrazole compound preferably is, for example, fipronil, ethiprole, and others. The phenylpyrazole compounds described above can be used alone or in combination of two or more.

The macrolide compound in the present invention is a compound having a macrolide ring which is, for example, a 12- to 18-membered lactone ring. Macrolide compounds are known, for example, as products from actinomycetes in soil. The use of a macrolide compound is preferable because it has effects of controlling lice, fleas, mites, and others which attach to animals such as companion animals and domestic animals, for example, by acting on nerves of these insect pests, thereby resulting in their death or repellence, and works as an active ingredient of the agent. The macrolide compound preferably is, for example, abamectin, dimadectin, doramectin, emamectin, eprinomectin, ivermectin, latidectin, lepimectin, selamectin, milbemectin, milbemycin oxime, moxidectin, nemadectin, emamectin benzoate salt, and others. The macrolide compounds described above can be used alone or in combination of two or more.

In the agent for use in an insect pest-controlling tool for animals according to the present invention, the active ingredient, which is a pyrethroid compound, a phenylpyrazole compound, or a macrolide compound, is contained in an amount of preferably 0.5 to 70 w/v %, further preferably 2 to 60 w/v %, more preferably 5 to 55 w/v %, further more preferably 10 to 55 w/v %, relative to the total amount of the agent, in order to exhibit elimination efficacy against insect pests such as mites, fleas, and mosquitoes.

### (Solvents in the Agent)

The solvent for use in an insect pest-controlling tool for animals according to the present invention is at least one selected from diethylene glycol monoethyl ether, benzyl alcohol, ethyl lactate, and a medium-chain fatty acid triglyceride. Any of these solvents is a compound that is liquid at room temperature of about 20 to 40° C. These solvents can be used alone or in combination of two or more.

The use of at least one selected from the group consisting of diethylene glycol monoethyl ether, benzyl alcohol, ethyl lactate, and a medium-chain fatty acid triglyceride makes it difficult that the inner wall part in the container body, which is made of a predetermined resin, is wetted with the solvent, thereby exerting an effect of leading to easy release of the agent enclosed in the container body.

As used herein, a medium-chain fatty acid triglyceride is a fatty acid triglyceride having 8 to 10 carbon atoms, more specifically, an ester compound which is obtained by reacting an unsaturated fatty acid having 8 to 10 carbon atoms with glycerin and has a molar ratio of unsaturated fatty acid to glycerin of 3:1. The medium-chain fatty acid triglyceride preferably is, for example, glyceryl tri (caprylate/caprate), glyceryl tricaprylate, glyceryl tricaprate, and the like. As a medium-chain fatty acid triglyceride, compounds extracted, such as from plants, or also compounds synthesized by chemical procedures can be used.

In the agent for use in an insect pest-controlling tool for animals according to the present invention, the solvent is contained in an amount of preferably 30 to 99.5 w/v %, further preferably 40 to 98 w/v %, more preferably 45 to 95 w/v %, further more preferably 45 to 90 w/v %, relative to the total amount of the agent, in order to diffuse the active ingredient on the skin of an animal.

In the present invention, the ratio of the active ingredient to the solvent is not limited, and is preferably 0.4 to 199 parts, further preferably 0.6 to 50 parts, more preferably 0.8 to 20 parts, further more preferably 0.8 to 9 parts, per 1 part of the active ingredient, in the ratio by w/v %.

### (Other Components)

In addition to at least one compound selected from a pyrethroid compound, a phenylpyrazole compound, and a macrolide compound, and at least one selected from the group consisting of diethylene glycol monoethyl ether, benzyl alcohol, ethyl lactate, and a medium-chain fatty acid triglyceride, other components can be mixed into the agent for use in an insect pest-controlling tool for animals according to the present invention, to the extent that they do not prevent the insect pest-controlling effect of the tool.

Other components that can be added to the agent for use in an insect pest-controlling tool for animals according to the present invention preferably are synergists. The use of a synergist allows inhibition of the metabolic decomposition of a pyrethroid compound, a phenylpyrazole compound, or a macrolide compound in the body of insect pests, thereby making it possible to provide a sustained effect of these compounds. Synergists are not particularly limited, and include, for example, ones belonging to inhibitors of microsomal multiple oxidases responsible for metabolic degradation in the body of insect pests.

Such a synergist includes, for example, piperonyl butoxide (5-[[2-(2-butoxyethoxy) ethoxy]methyl]-6-propyl-1,3-benzodioxole), osesamin, sesamolin, sesamex, propyl isome, safroxan, sulfoxide, piperonyl cyclonene, N-(2-ethyl) hexyl-5,6-norbornene dicarboximide, 2,2′, 3,3, 3,3′,3′,3′-octachlorodipropyl ether, O-propargyl-O-propyl phenylphosphonate, and others. In particular, piperonyl butoxide is preferable. These synergists may be used alone or in conjunction of two or more.

By no way of limitation, the synergist may not be contained in the agent; when contained, the synergist is preferably contained at 0.5 to 10 w/v % and may be contained at 1 to 8 w/v %, relative to the total amount of the agent.

Other components that can be added to the agent for use in an insect pest-controlling tool for animals according to the present invention preferably are insect growth regulators. Even though there are insect pests resistant to a pyrethroid compound, a phenylpyrazole compound, or a macrolide compound, the use of an insect growth regulator leads to suppression of their growth, thereby making it possible to suppress their propagation and reduce insect pests over time. Insect growth regulators are not particularly limited, and include, for example, ones belonging to juvenile hormone-like substances or chitin synthesis inhibitors.

Such an insect growth regulator includes, for example, pyriproxyfen, S-methoprene, hydroprene, fenoxycanoleb, etoxazole, chlorfluazuron, fluazuron, triazuron, novaluron, hexaflumuron, diflubenzuron, cyromazine, flufenoxuron, teflubenzuron, triflumuron, flucycloxuron, hydroprene, lufenuron, noviflumuron, bistrifluron, and others. In particular, pyriproxyfen and S-methoprene are preferable. These insect growth regulators may be used alone or in conjunction of two or more.

By no way of limitation, the insect growth regulator is preferably contained in the agent in an amount of 0.1 to 20 w/v %, further preferably 0.2 to 15 w/v %, more preferably 0.5 to 12 w/v %, relative to the total amount of the agent.

Other components that can be added to the agent for use in an insect pest-controlling tool for animals according to the present invention preferably are natural essential oil components. Natural essential oil components are volatile oily materials obtained, for example, from branches, leaves, rootstalks, barks, fruits, flowers, buds, or resins of plants, and are compounds obtained by separation and purification from different parts of plants through methods such as steam distillation, expression, and extraction.

Raw materials from which essential oils are derived are widely varied, and preferably are grapefruit, geranium, rosemary, anise, armoise (wormwood), ylang-ylang, orange, cananga, chamomile, cardamom, cajupt, clary sage, clove, coriander, cypress, sandalwood, cedarwood, citronella, juniper berry, ginger, spearmint, sage, tea tree, nutmeg, neroli, pine needles, basil, patchouli, palmarosa, fennel, black pepper, petitgrain (bitter orange), vetiver, peppermint, bergamot, marjoram, mandarin, eucalyptus lemon, lime, lavender, lemon, lemongrass, rosewood, shell ginger (Alpinia zerumbet) leaf oil, cinnamon oil, and mint oil. Essential oils obtained from these raw materials have a useful repellent effect against insect pests. An essential oil comprises different volatile compounds, and thus users of an insect pest-controlling tool for animals according to the present invention, through their sense of smell, can become aware that the tool has a significant decrease of the controlling effect of the tool when the aroma of the essential oil contained in the agent disappears, and can easily ascertain the controlling effect which is difficult to recognize through their sense of sight.

An essential oil obtained from a raw material described above comprises various volatile compounds. Grapefruit essential oil comprises d-limonene, myrcene, and α-pinene, etc. Geranium essential oil comprises citronellol, geraniol, and linalool, etc. Rosemary essential oil comprises α-pinene, camphor, and 1,8-cineole, etc. Anise essential oil comprises (E)-anethole, limonene, and anisaldehyde, etc. Armoise essential oil comprises 1,8-cineole, thujone, borneol, camphor, pinene, artemisinin (sesquiterpene lactone) linalool, and nerol, etc. Ylang ylang essential oil comprises linalool, β-caryolephyne, and germacrene D, etc. Orange essential oil comprises limonene, myrcene, and β-bisabolene, etc. Cananga essential oil comprises caryophyllene, geranyl acetate, and terpineol, etc. Chamomile essential oil comprises farnesene, chamazulene, and α-bisabolol oxide B, etc. Cardamom essential oil comprises 1,8-cineole, α-terpinyl acetate, and limonene, etc. Cajupte essential oil comprises 1,8-cineole, α-terpineol, and para-cymene, etc. Clary sage essential oil comprises linalyl acetate, linalool, and germacrene D, etc. Clove essential oil comprises eugenol, β-caryophyllene, and eugenyl acetate, etc. Coriander essential oil comprises d-linalool, camphor, and α-pinene, etc. Cypress essential oil comprises α-pinene, and δ-3-carene, etc. Sandalwood essential oil comprises cis-α-santalol, cis-β-santalol, and epi-β-santalol, etc. Cedarwood essential oil comprises thujopsene, α-cedrene, and cedrol, etc. Citronella essential oil comprises geraniol, limonene, and citronellol, etc. Juniper berry essential oil comprises α-pinene, myrcene, and β-farnesene, etc. Ginger essential oil comprises ar-curcumene, α-zingiberene, and β-sesquiphellandrene, etc. Spearmint essential oil comprises (−)-carvone, dihydrocarvone, and 1,8-cineole, etc. Sage essential oil comprises α-thujone, β-thujone, and camphor, etc. Tea tree essential oil comprises terpinene-4-ol, γ-terpinene, and α-terpinene, etc. Nutmeg essential oil comprises α-pinene, sabinene, and β-pinene, etc. Neroli essential oil comprises linalool, limonene, and β-pinene, etc. Pine needle essential oil comprises α-pinene, β-pinene, and myrcene, etc. Basil essential oil comprises linalool, methyl chavicol, and β-caryophyllene, etc. Patchouli essential oil comprises patchouli alcohol, α-patchoulene, and β-caryophyllene, etc. Palmarosa essential oil comprises geraniol, geranyl acetate, and linalool, etc. Fennel essential oil comprises (E)-anethole, limonene, and methyl chavicol, etc. Black pepper essential oil comprises β-3-caryophyllene, δ-3-carene, and limonene, etc. Petitgrain essential oil comprises linalyl acetate, linalool, and α-terpineol, etc. Vetiver essential oil comprises vetiverol, vetivene, and α-vetivol, etc. Bergamot essential oil comprises limonene, linalyl acetate, and linalool, etc. Merjoram essential oil comprises terpinene-4-ol, cis-sabinene hydrate, and para-cymene, etc. Mandarin essential oil comprises limonene, γ-terpinene, and β-pinene, etc. Eucalyptus lemon essential oil comprises citronellal, citronellol, and citral, etc. Lime essential oil comprises limonene, γ-terpinene, and β-pinene, etc. Lavender essential oil comprises linalyl acetate, linalool, and (Z)-β-ocimene, etc. Lemon essential oil comprises limonene, β-pinene, and γ-terpinene, etc. Lemongrass essential oil comprises geranial, citral, and elemol, etc. Rosewood essential oil comprises linalool, α-terpineol, and cis-linalool oxide, etc. Peppermint essential oil comprises 1-menthol, 1-menthone, and menthofuran, etc. Cinnamon oil comprises cinnamaldehyde, t-2-methoxycinnamaldehyde, and coumarin, etc. Shell ginger leaf oil comprises 1,8-cineole, terpinene-4-ol, and p-cymene, etc. Mint oil comprises 1-menthol, 1-menthone, and menthofuran, etc.

In addition, other components that can be added to the agent for use in an insect pest-controlling tool for animals according to the present invention preferably are perfumes that users of the tool can sense through their sense of smell. Further preferable are perfumes that have a vapor pressure equal to or within a range of plus or minus 20% of that at a predetermined temperature of the pyrethroid compound, the phenylpyrazole compound, or the macrolide compound used, or of the essential oil used. By the use of perfumes in the agent, users of an insect pest-controlling tool for animals according to the present invention, through their sense of smell, can become aware that the tool has a significant decrease of the controlling effect of the tool when the aroma of the essential oil contained in the agent disappears, and can easily ascertain the controlling effect which is difficult to recognize through their sense of sight. Incorporation of a perfume into the agent makes it possible that users of the tool easily ascertain the controlling effect especially when a pyrethroid compound, a phenylpyrazole compound, a macrolide compound, and an essential oil which are difficult to sense through their sense of smell are used.

The container in an insect pest-controlling tool for animals according to the present invention includes a container body that holds an agent containing at least one or more active ingredients selected from a pyrethroid compound, a phenylpyrazole compound, or a macrolide compound which is an active ingredient, and a solvent.

### (Container Body)

The container body is of a laminate comprising a first olefin resin layer, an alicyclic olefin resin layer, a second olefin resin layer, and a polyethylene terephthalate layer or an ethylene-vinyl alcohol copolymer layer. One of the olefin resin layers is preferably placed facing the agent. Preferably, a first olefin resin layer, an alicyclic olefin resin layer, a second olefin resin layer, and a polyethylene terephthalate layer or an ethylene-vinyl alcohol copolymer layer are preferably placed in this order and in contact. In some cases, an adhesive layer may be included between the second olefin resin layer and the polyethylene terephthalate layer or the ethylene-vinyl alcohol copolymer layer. Additionally, an optionally colored, printed layer may be included to configure the container body.

In the present invention, the respective olefin resin layers are of a polymer obtained by using an olefinic compound(s) such as ethylene and propylene, and is of a polyethylene alone, a polypropylene alone, a copolymer of ethylene and propylene, or a resin in which a polyethylene and a polypropylene are blended, and is preferably made of a copolymer of ethylene and propylene.

The melt flow rate (MFR) value of the respective olefin resins is not limited, and is preferably 1.5 g to 10 g/10 min, further preferably 2.5 g to 8.0 g/10 min. The MFR value of the respective olefin resins lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The melt flow rates described above are numerical values as measured pursuant to JIS K 7210 ISO.

The tensile modulus of the respective olefin resins preferably is 1000 MPa to 2000 MPa, more preferably 1250 MPa to 1500 MPa. The tensile modulus of the respective olefin resins lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The tensile moduli described above are numerical values as measured by a method pursuant to JIS K 7161.

The Rockwell hardness value of the respective olefin resins preferably is R80 to R110, more preferably R90 to R100. The Rockwell hardness value of the respective olefin resins lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The Rockwell hardness values are those as measured by a method pursuant to JIS K 7202 or others.

The alicyclic olefin resin layer, which comprises an alicyclic olefin resin, preferably is, for example, of an alicyclic olefin resin alone, or one like an alicyclic olefin resin in which a polyethylene is mixed or copolymerized in a predetermined amount.

The alicyclic olefin resin is of a polymer obtained by using a monocyclic or bicyclic alicyclic compound(s), such as at least cyclopropene, cyclobutene, cyclohexene, cycloheptene, cyclooctene, norbornene, and norbornadiene, preferably of a copolymer of the alicyclic compound(s) and an olefin(s), such as ethylene and propylene, more preferably of a copolymer of norbornene and ethylene. Even though a solvent having high wetting properties on common resins is used in the agent, the use of the alicyclic olefin resin makes it possible to yield an insect pest-controlling tool for animals according to the present invention that has excellent stability over time without dissolution or swelling of the resin in the solvent. The use of the alicyclic olefin resin also makes it possible to yield an insect pest-controlling tool for animals according to the present invention that has excellent stability over time even though the tool is stored in places where sunlight shines, because deterioration of the resin due to ultraviolet rays is hard to occur.

The glass transition temperature of the alicyclic olefin resin preferably is 40 to 220° C., further preferably 60 to 180° C., with 70 to 90° C. being preferred. The glass transition temperature of the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The glass transition temperatures described above are numerical values as measured by a method using differential scanning calorimetry (DSC), pursuant to ISO 11375-1, -2, or -3, JIS K 7121-1987, or others.

The tensile modulus of the alicyclic olefin resin preferably is 2000 to 3500 MPa, further preferably 2300 to 3200 MPa, most preferably 2400 to 2900 MPa. The tensile modulus of the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The tensile moduli described above are numerical values as measured by a method pursuant to ISO 527, JIS K 7161 to 7165, or others.

The pencil hardness of the alicyclic olefin resin preferably is 4H to 4B, further preferably 2H to 2B, most preferably H to B. The pencil hardness of the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The pencil hardnesses described above are values as measured by a method pursuant to JIS K 5401 or others.

When the alicyclic olefin resin is a copolymer of an alicyclic compound described above and a linear or branched olefin (which is an olefin that is not an alicyclic compound) such as ethylene or propylene, the content percentage of the alicyclic compound in the resin preferably is 50 to 90 mass %, further preferably 60 to 85 mass %, most preferably 62 to 70 mass %.

For example, the alicyclic olefin resin can be a copolymer made of norbornene at a content percentage of preferably 50 to 90 mass %, further preferably 60 to 85 mass %, more preferably 62 to 70 mass %, and ethylene at a content percentage of preferably 10 to 49 mass %, further preferably 15 to 40 mass %, more preferably 30 to 38 mass %.

In the case of the above-described copolymer, the content percentage of the alicyclic compound in the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out.

The polyethylene terephthalate layer is of a polyethylene terephthalate obtained from an aromatic dicarboxylic acid, including terephthalic acid or an ester derivative thereof, and a diol, including ethylene glycol. From the viewpoint of moldability, for example, into container shapes, amorphous polyethylene terephthalate is preferable. The ethylene-vinyl alcohol copolymer layer is not particularly limited, as long as it is of an ethylene-vinyl alcohol resin. Preferably, an ethylene-vinyl alcohol resin under the trade name “EVAL” (manufactured by Kuraray Co., Ltd.) can be used.

Optionally, a printed layer or an adhesive layer can also be provided between the polyethylene terephthalate layer or the ethylene-vinyl alcohol copolymer layer and the second polyolefin resin layer.

The container body can be obtained by molding a sheet of the laminate having, before molding, a thickness of preferably 250 to 550 μm, further preferably 300 to 500 μm, more preferably 350 to 450 μm, most preferably about 415 μm±20. The resin-layer laminate composing the container body after molding has a thickness of 100 to 500 μm.

The thickness of the respective olefin resin layers in the laminate sheet before molding is not limited, and can be preferably 10 to 40 μm, further preferably 15 to 35 μm, more preferably 20 to 30 μm, most preferably about 25 μm±1 μm. The thickness of the alicyclic olefin resin layer in the laminate sheet before molding is not limited, and can be preferably 200 to 450 μm, further preferably 250 to 400 μm, more preferably 300 to 400 μm, most preferably about 350 μm±10 μm. The thickness of the polyethylene terephthalate layer or the ethylene-vinyl alcohol copolymer layer in the laminate sheet before molding can be preferably about 10 to 30 μm, further preferably 12 to 20 μm, more preferably 13 to 20 μm, most preferably 16 μm±1 μm.

By no way of limitation, an embodiment of the laminate of the container body preferably is one in which, for example, from the inside of the container for an agent to be held therein, an olefin resin layer made of a copolymer of ethylene and propylene, an alicyclic olefin resin layer made of a copolymer of norbornene and ethylene, and an olefin resin layer made of a copolymer of ethylene and propylene are sequentially positioned in contact, followed by an adhesive layer and a printed layer, followed by a polyethylene terephthalate layer or an ethylene-vinyl alcohol copolymer layer.

The thickness of the respective olefin resin layers made of a copolymer of ethylene and propylene in the laminate sheet before molding is not limited, and can be preferably 10 to 40 μm, further preferably 15 to 35 μm, more preferably 20 to 30 μm, most preferably about 25 μm±1 μm. The thickness of the alicyclic olefin resin layer made of a copolymer of norbornene and ethylene is not limited, and can be preferably 200 to 450 μm, further preferably 250 to 400 μm, more preferably 300 to 400 μm, most preferably about 350 μm±10 μm. The thickness of the polyethylene terephthalate layer or the ethylene-vinyl alcohol copolymer layer can be preferably about 10 to 30 μm, further preferably 12 to 20 μm, more preferably 13 to 20 μm, most preferably 16 μm±1 μm.

The use of a container body with a laminated structure as mentioned above makes it possible that the agent is held therein stably over time, and at the same time, that the agent is easily taken out from the container body and through the lid part thereof, and can improve the strength thereof.

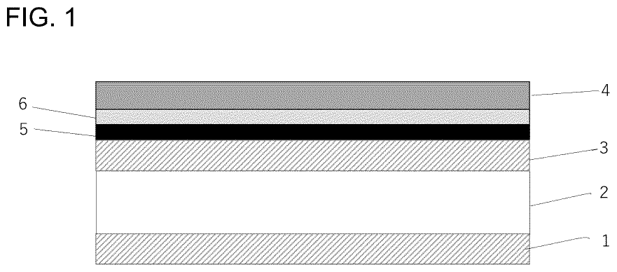

By no way of limitation, a container body can be composed in the laminate shown in FIG. 1. In FIG. 1, the laminate can be formed by providing, in a sandwich manner, a lower surface and an upper surface of an alicyclic olefin resin layer 2 with a first and a second unstretched film 1 and 3 made of an ethylene/propylene copolymer, respectively, and further placing, on the other surface of the second unstretched film 3 made of the ethylene/propylene copolymer, an adhesive layer 5 and a printed layer 6, followed by a polyethylene terephthalate layer or an ethylene-vinyl alcohol copolymer layer 4. Typically, the first unstretched film 1 made of an ethylene/propylene copolymer is formed as a side of the laminate that is in contact with the agent.

### (Lid Part)

The lid part is sealed to the edge of a box-shaped container body having an opening, and is useful for the agent held in the container to be enclosed therein. The agent can be taken out by breaking a portion of the container body and the lid part. The lid part is not particularly limited, and preferably is of a laminate of one or more than one material selected from the group consisting of an alicyclic olefin resin, polyethylene terephthalate, polypropylene, polyethylene, and aluminum. More preferably, the lid part comprises at least a combination of aluminum and an alicyclic olefin resin, polyethylene terephthalate, polypropylene, or polyethylene. For example, the lid part is most preferably a laminate like a structure consisting of four layers of polyethylene terephthalate, aluminum, polyethylene terephthalate, and polypropylene, or of four layers of polyethylene terephthalate, aluminum, polyethylene terephthalate, and an alicyclic olefin resin. These layers can be bonded, for example, by vapor deposition, or with an adhesive.

The alicyclic olefin resin is of a polymer obtained by using a monocyclic or bicyclic alicyclic compound(s), such as at least cyclopropene, cyclobutene, cyclohexene, cycloheptene, cyclooctene, norbornene, and norbornadiene, preferably of a copolymer of the alicyclic compound(s) and an olefin(s), such as ethylene and propylene, more preferably of a copolymer of norbornene and ethylene. Even though diethylene glycol monoethyl ether having high wetting properties on common resins is used as the solvent in the agent, the use of the alicyclic olefin resin makes it possible to yield an insect pest-controlling tool for animals according to the present invention that has excellent stability over time without dissolution or swelling of the resin in the solvent. The use of the alicyclic olefin resin also makes it possible to yield an insect pest-controlling tool for animals according to the present invention that has excellent stability over time even though the tool is stored in places where sunlight shines, because deterioration of the resin due to ultraviolet rays is hard to occur. The alicyclic olefin resin can use either stretched or unstretched films.

The glass transition temperature of the alicyclic olefin resin preferably is 40 to 220° C., further preferably 60 to 180° C., with 70 to 90° C. being preferred. The glass transition temperature of the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The glass transition temperatures described above are numerical values as measured by a method using differential scanning calorimetry (DSC), pursuant to ISO 11375-1, -2, or -3, JIS K 7121-1987, or others.

The tensile modulus of the alicyclic olefin resin preferably is 2000 to 3500 MPa, further preferably 2300 to 3200 MPa, most preferably 2400 to 2900 MPa. The tensile modulus of the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The tensile moduli described above are numerical values as measured by a method pursuant to ISO 527, JIS K 7161 to 7165, or others.

The pencil hardness of the alicyclic olefin resin preferably is 4H to 4B, further preferably 2H to 2B, most preferably H to B. The pencil hardness of the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out. The pencil hardnesses described above are values as measured by a method pursuant to JIS K 5401 or others.

When the alicyclic olefin resin is a copolymer of an alicyclic compound as described above and an olefin such as ethylene or propylene, the content percentage of the alicyclic compound in the resin preferably is 50 to 90 mass %, further preferably 60 to 85 mass %, most preferably 62 to 70 mass %. The content percentage of the alicyclic compound in the alicyclic olefin resin lying in this range is preferable because the laminate is easily processed into a predetermined shape while ensuring its strength capable of withstanding use, and additionally because a molded container made of the laminate is easily broken, for example, by bending it by hand, when the agent held in the container is taken out.

By no way of limitation, an insect pest-controlling tool for animals according to the present invention is preferably used by dropping the agent in the tool onto the skin on the back of the neck (between the shoulder blades) of an animal. Treatments with the agent can be used by dropping about 2 to 3 drops of the agent once a day. Typically, the agent can be applied about once every 2 weeks to 1 month, or about once every 2 to 3 months.

The present invention also includes the following aspects:

[1] An insect pest-controlling tool for animals, comprising:

an agent containing:

0.5 to 70 w/v % of at least one active ingredient selected from the group consisting of a pyrethroid compound, a phenylpyrazole compound, and a macrolide compound; and

30 to 99.5 w/v % of at least one solvent selected from the group consisting of diethylene glycol monoethyl ether, benzyl alcohol, ethyl lactate, and a medium-chain fatty acid triglyceride; and

a container body in which the agent held,

wherein the container body is of a laminate comprising a first olefin resin layer, an alicyclic olefin resin layer, a second olefin resin layer, and a polyethylene terephthalate layer or an ethylene-vinyl alcohol copolymer layer, and

wherein the first olefin resin layer is placed facing the agent:

[2] The insect pest-controlling tool for animals according to [1], wherein the agent further comprises 1 to 10 w/v % of a synergist and 0.1 to 5 w/v % of an insect growth regulator:

[3] An insect pest-controlling tool for animals, comprising:

an agent containing:

at least one active ingredient selected from the group consisting of a pyrethroid compound, a phenylpyrazole compound, and a macrolide compound; and

at least one solvent selected from the group consisting of diethylene glycol monoethyl ether, benzyl alcohol, ethyl lactate, and a medium-chain fatty acid triglyceride; and

a container body in which the agent is held,

wherein the container body is of a laminate comprising a first olefin resin layer, an alicyclic olefin resin layer, a second olefin resin layer, and a polyethylene terephthalate layer or an ethylene-vinyl alcohol copolymer layer, and

wherein the first olefin resin layer is placed facing the agent, and

wherein the alicyclic olefin resin is a copolymer of norbornene and a linear or branched olefin, and both the first and second olefin resins are of a copolymer of polyethylene and polypropylene:

[4] The insect pest-controlling tool for animals according to [3], wherein the copolymer of norbornene and ethylene has a content percentage of norbornene of 50 to 90 w/v& and a content percentage of the linear or branched olefin of 10 to 50 w/v %.

[5] The insect pest-controlling tool for animals according to any of [1] to [4], further comprising a lid part that covers an opening of the container body and is of a laminate of two or more materials selected from the group consisting of an alicyclic olefin resin, polyethylene terephthalate, polypropylene, polyethylene, and aluminum:

[6] The insect pest-controlling tool for animals according to any of [1] to [5], wherein the active ingredient is a pyrethroid compound, which is at least one selected from the group consisting of etofenprox, phenothrin, and allethrin:

[7] The insect pest-controlling tool for animals according to any of [1] to [5], wherein the active ingredient is a phenylpyrazole compound, fipronil:

and others.

### EXAMPLES

### Agent Preparation Example 1

An agent was prepared by adding 4.0 w/v % of piperonyl butoxide as a synergist to 16 w/v % of phenorin and 1.6 vol % of allethrin as pyrethroid compounds which were active ingredients, and additionally 0.5 w/v % of pyriproxyfen as an insect growth regulator, to which a solvent, diethylene glycol monoethyl ether, was then added to make 100 w/v %.

### Example 1

A container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm thick unstretched film made of an ethylene/propylene copolymer, respectively, and further laminating a 16-μm thick polyethylene terephthalate layer on the other surface of one unstretched film made of the ethylene/propylene copolymer.

The agent prepared in Agent Preparation Example 1 was filled in the resulting container body, to which was heat-welded a lid part obtained by dry laminating a 4-layer structure of a 12-μm thick polyethylene terephthalate, a 20-μm thick aluminum film, a 12-μm thick polyethylene terephthalate film, and a 30-μm thick polypropylene film, to produce an insect-pest-controlling tool for animals. In this tool, the agent within the container body is in contact with the ethylene/propylene copolymer film provided on the side opposite to the polyethylene terephthalate film.

### Example 2

The same agent as in Example 1 was used. As the container body for containing the agent, a container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm thick unstretched film made of an ethylene/propylene copolymer, respectively, and further placing a 30-μm thick layer of an ethylene-vinyl alcohol copolymer (available under the trade name “EVAL”) on the other surface of one unstretched film made of the ethylene/propylene copolymer, to produce an insect pest-controlling tool for animals as in Example 1.

### Comparative Example 1

As the container body for containing the agent, a container body was made which consisted of a single 400-μm thick layer of an alicyclic olefin resin made of a copolymer of norbornene and ethylene (with a content percentage of norbornene of 76 mass %) having a glass transition temperature of 138° C., a tensile modulus of 2400 MPa, and a pencil hardness of HB, to produce an insect pest-controlling tool for animals as in Example 1.

### Comparative Example 2

As the container body for containing the agent, a container body was made which consisted of a single 400-μm thick layer of an alicyclic olefin resin made of a copolymer of norbornene and ethylene (with a content percentage of norbornene of 65 mass %) having a glass transition temperature of 78° C., a tensile modulus of 2100 MPa, and a pencil hardness of HB, to produce an insect pest-controlling tool for animals as in Example 1.

### Comparative Example 3

As the container body for containing the agent, a container body was made which consisted of a single 400-μm thick layer of an alicyclic olefin resin made of a copolymer of norbornene and ethylene (with a content percentage of norbornene of 76 mass %) having a glass transition temperature of 138° C., a tensile modulus of 2400 MPa, and a pencil hardness of HB, to produce an insect pest-controlling tool for animals as in Example 1.

### Comparative Example 4

As the container body for containing the agent, a container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm film made of an ethylene/propylene copolymer, respectively, to produce an insect pest-controlling tool for animals as in Example 1.

### Agent Preparation Example 2

An agent was prepared by adding 10 w/v % of fipronil as a phenylpyrazole compound and additionally 12 w/v % of methoprene as an insect growth regulator, both of which were active ingredients, before adding a solvent, diethylene glycol monoethyl ether, to make 100 w/v %.

### Agent Preparation Example 3

An agent was prepared by adding 40 w/v % of etofenprox as a pyrethroid compound and 0.5 w/v % of pyriproxyfen as an insect growth regulator, both of which were active ingredients, before adding a solvent, diethylene glycol monoethyl ether, to make 100 w/v %.

### Example 3

A container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm thick unstretched film made of an ethylene/propylene copolymer, respectively, and further laminating a 16-μm thick polyethylene terephthalate layer on the other surface of one unstretched film made of the ethylene/propylene copolymer.

The agent prepared in Agent Preparation Example 2 was filled in the container body, to which was heat-welded a lid part obtained by dry laminating a 4-layer structure of a 12-μm thick polyethylene terephthalate, a 20-μm thick aluminum film, a 12-μm thick polyethylene terephthalate film, and a 30-μm thick polypropylene film, to produce an insect-pest-controlling tool for animals. In this tool, Agent 2 within the container body is in contact with the ethylene/propylene copolymer film provided on the side opposite to the polyethylene terephthalate film.

### Example 4

The same agent as in Example 3 was used. As the container body for containing the agent, a container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm thick unstretched film made of an ethylene/propylene copolymer, respectively, and further placing a 30-μm thick layer of an ethylene-vinyl alcohol copolymer (available under the trade name “EVAL”) on the other surface of one unstretched film made of the ethylene/propylene copolymer, to produce an insect pest-controlling tool for animals as in Example 3.

### Example 5

A container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm thick unstretched film made of an ethylene/propylene copolymer, respectively, and further laminating a 16-μm thick polyethylene terephthalate layer on the other surface of one unstretched film made of the ethylene/propylene copolymer.

The agent prepared in Agent Preparation Example 3 was filled in the container body, to which was heat-welded a lid part obtained by dry laminating a 4-layer structure of a 12-μm thick polyethylene terephthalate, a 20-μm thick aluminum film, a 12-μm thick polyethylene terephthalate film, and a 30-μm thick polypropylene film, to produce an insect-pest-controlling tool for animals. In this tool, Agent 2 within the container body is in contact with the ethylene/propylene copolymer film provided on the side opposite to the polyethylene terephthalate film.

### Example 6

The same agent as in Example 5 was used. As the container body for containing the agent, a container body was made by providing, in a sandwich manner, a lower surface and an upper surface of a 350-μm thick layer of an alicyclic olefin resin made of a copolymer of norbornene and ethylene (with a content percentage of norbornene of 65 mass %) having a glass transition temperature of 78° C., a tensile modulus of 2200 MPa, and a pencil hardness of HB, with a 25-μm thick unstretched film made of an ethylene/propylene copolymer, respectively, and further placing a 30-μm thick layer of an ethylene-vinyl alcohol copolymer (available under the trade name “EVAL”) on the other surface of one unstretched film made of the ethylene/propylene copolymer, to produce an insect pest-controlling tool for animals as in Example 3.

### [Oxygen Permeability Evaluation]

The container bodies obtained in the Examples and Comparative Examples were subjected to evaluation of oxygen permeability at 23° C. and 65% RH. The evaluation was based on measurements with the MOCON method.

### [Breakability Evaluation]

A knife was used to make a notch in the container bodies from Examples and Comparative Examples, which were then subjected to their sensory evaluation of breakability when the notched surface was turned upward and the container body was bended by hand. The evaluation was based on the following criteria:

when the container body was easily broken without strong force: ◯

when the container body was broken with a slight force: Δ

when the container body was too soft to break or was not broken without strong force: ×

### [Properties Evaluation]

Visual observation was made for the transparency of the containers when the container bodies of Examples and Comparative Examples were formed by vacuum molding. The evaluation was based on the following criteria:
when the container was transparent: ◯

when there appeared a slightly white cloudy area which was not remarkable: Δ

when there appeared a remarkable, white cloudy area: ×

### [Sensory Evaluation of Odor]

Each of the insect pest-control tools for animals produced in Examples and Comparative Examples was placed in a packaging having an aluminum film, which was kept and stored in a temperature-controlled oven at 40° C. for 1 month. After that, the packaging was taken out from the oven and put into a tray, and the aluminum film was peeled off from the packaging before sensory evaluation was performed on the odor in the tray. The evaluation was based on the following criteria:

when no odor was noticed: ◯

when slight odor was noticed: Δ

when odor was noticed: X

Table 1 shows the evaluation results for the insect pest-controlling tool for animals.

TABLE 1

| | Oxygen | | Properties/ | |
|---|---|---|---|---|
| | Permeability | Breakability | Transparency | Odor |
| Example 1 | 7 | ◯ | ◯ | ◯ |
| Example 2 | 10.2 | ◯ | ◯ | ◯ |
| Comparative | 30 | ◯ | X | Δ |
| Example 1 | | | | |
| Comparative | 57.3 | ◯ | ◯ | X |
| Example 2 | | | | |
| Comparative | 100< | ◯ | X | X |
| Example 3 | | | | |
| Comparative | 69.6 | ◯ | ◯ | Δ |
| Example 4 | | | | |

In particular, individual results from their sensory evaluation of odor observations are as shown in Table 2 below.

TABLE 2

| | Evaluation Results | | | | | |
|---|---|---|---|---|---|---|
| | | | Compar- | Compar- | Compar- | Compar- |
| Ob- | | | ative | ative | ative | ative |
| serv- | Exam- | Exam- | Exam- | Exam- | Exam- | Exam- |
| er | ple 1 | ple 2 | ple 1 | ple 2 | ple 3 | ple 4 |
| A | ◯ | ◯ | X | Δ | X | Δ |
| B | ◯ | Δ | ◯ | X | X | Δ |
| C | Δ | ◯ | Δ | X | X | X |
| D | ◯ | ◯ | X | X | X | X |
| E | ◯ | ◯ | Δ | Δ | X | Δ |

The sensory evaluation of odor observations was also performed for the insect pest-controlling tool for animals according to Examples 3 to 6. Individual results from their sensory evaluation are as shown in Table 3 below.

TABLE 3

Evaluation Results

| Observer | Example 3 | Example 4 | Example 5 | Example 6 |
|---|---|---|---|---|
| A | ◯ | ◯ | ◯ | ◯ |
| B | ◯ | ◯ | ◯ | ◯ |
| C | ◯ | ◯ | ◯ | ◯ |
| D | Δ | Δ | ◯ | ◯ |
| E | Δ | ◯ | ◯ | ◯ |

From these results, it follows that the insect pest-controlling tools for animals according to Examples 1 and 2 comprises a container body provided with suppressed oxygen permeation, suppressed leakage of odor, and good breakability and properties such as transparency. It was ascertained that the moldability of the laminates prepared in Examples was such that the insect pest-controlling tools for animals produced using them had no problems in terms of product.

It was also ascertained that the leakage of odor was suppressed for the insect pest-controlling tools for animals according to Examples 3 to 6, in the sensory evaluation test which was performed using the same container and the different agents as in Examples 1 to 2.

In the insect pest-controlling tools for animals according to Comparative Examples 1 and 3, comprising a container composed of a single layer, on the other hand, their containers were problematic in terms of breakability, but there appeared a white cloudy area(s) thereon. In addition, it was found that the effect of suppressing oxygen permeation was not as high as that of the insect pest-controlling tools for animals according to Example 1 or 2. The insect pest-controlling tools for animals according to Comparative Examples 2 and 4 caused leakage of odor, and were found not to be as good as those according to the Examples.

1. An insect pest-controlling tool for animals, comprising:
an agent containing:
at least one active ingredient selected from the group consisting of a pyrethroid compound, a phenylpyrazole compound, and a macrolide compound; and
at least one solvent selected from the group consisting of diethylene glycol monoethyl ether, benzyl alcohol, ethyl lactate, and a medium-chain fatty acid triglyceride; and
a container body in which the agent is held,
wherein the container body is of a laminate comprising a first olefin resin layer, an alicyclic olefin resin layer, a second olefin resin layer, and a polyethylene terephthalate layer or an ethylene-vinyl alcohol copolymer layer, and
wherein the first olefin resin layer is placed facing the agent.

2. The insect pest-controlling tool for animals according to claim 1, further comprising a lid part that covers an opening of the container body and is of a laminate of two or more materials selected from the group consisting of an alicyclic olefin resin, polyethylene terephthalate, polypropylene, polyethylene, and aluminum.

3. The insect pest-controlling tool for animals according to claim 1, wherein the alicyclic olefin resin is a copolymer of norbornene and ethylene.

4. The insect pest-controlling tool for animals according to claim 1, wherein each of the olefin resin layers is of a copolymer of polyethylene and polypropylene.

5. The insect pest-controlling tool for animals according to claim 1, wherein the active ingredient is a pyrethroid compound, which is at least one selected from the group consisting of etofenprox, phenothrin, and allethrin.

6. The insect pest-controlling tool for animals according to claim 1, wherein the active ingredient is a phenylpyrazole compound, fipronil.
